(19) United States
(12) Patent Application Publication
(10) Pub. No.: US 2005/0243736 A1
(43) Pub. Date: Nov. 3, 2005

(54) System, method, and service for finding an optimal collection of paths among a plurality of paths between two nodes in a complex network

(75) Inventors: Christos Faloutsos, Pittsburgh, PA (US); Kevin Snow McCurley, San Jose, CA (US); Andrew S. Tomkins, San Jose, CA (US)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/827,784

(22) Filed: Apr. 19, 2004

(51) Int. Cl. H04L 1/00

(52) U.S. Cl. 370/254

(57) ABSTRACT

An optimal path selection system extracts a connection subgraph in real time from an undirected, edge-weighted graph such as a social network that best captures the connections between two nodes of the graph. The system models the undirected, edge-weighted graph as an electrical circuit and solves for a relationship between two nodes in the undirected edge-weighted graph based on electrical analogues in the electric graph model. The system optionally accelerates the computations to produce approximate, high-quality connection subgraphs in real time on very large (disk resident) graphs. The connection subgraph is constrained to the integer budget that comprises a first node, a second node and a collection of paths from the first node to the second node that maximizes a “goodness” function g(H). The goodness function g(H) is tailored to capture salient aspects of a relationship between the first node and the second node.

### FIELD OF THE INVENTION

The present invention generally relates to data mining and more specifically to a method for discovering relationships between nodes in an undirected edge-weighted graph using a connection subgraph. In particular, the present invention pertains to determining an optimum set or collection of paths between a first node and a second node by which the optimum set of paths describes a relationship between the first node and the second node.

### BACKGROUND OF THE INVENTION

The term “complex networks” is sometimes used to describe a collection of relationships between entities. Reference is made to M. E. J. Newman, “The structure and function of complex networks,” SIAM Review 45, 167-256 (2003). Examples of complex networks arise as information networks, social networks, technological networks, or biological networks. In the case of information networks the entities could be web pages, for which the relationships are hyperlinks; scientific publications, for which the relationships are citations; and patents, for which the relationships are also citations.

In social networks, the entities can be individuals, groups, or organizations, and examples of relationships could be sexual contact, disease transmission, or communications via email, telephone, or physical meetings. An example of a biological is a metabolic network, in which the entities are metabolic substrates, and the relationships are chemical reactions between the substrates. Examples of technological networks include the electrical power grid (nodes are power plants, and edges are power lines), and the Internet (nodes are routers or machines, and edges are network connections).

In each of these domains, the complex network can be modeled as an undirected, edge-weighted graph. The analysis of such graphs has proven to be useful in a number of ways, including understanding the nature of life, the spread of information, disease, or computer viruses, or understanding of relationships between bodies of information (e.g., websites).

The purpose of a connection subgraph in a complex network is to mathematically model the most significant connections between two entities of the network. Connection subgraphs are useful in many domains. In a social network setting, connection subgraphs help identify the few most likely paths of transmission for a disease (or rumor, or information-leak, or joke) from one person to another. Connection subgraphs can also help spot whether an individual has unexpected ties to any members of a list of individuals; this could be especially useful in detecting criminal or terrorist activity.

In other domains, connection subgraphs help summarize the connection between two web sites using the hyper-link graph, the connection between two proteins in a metabolic network, or the connection between two genes in a regulatory network. Consequently, accurate and efficient methods of modeling social networks are a high priority for many applications.

A primary product of a social network is the relationship between two entities or nodes, “A” and “B”. In the simplest case, the relationship is manifest as an edge in the graph. However, complex network graphs are typically sparse, meaning that a vanishing fraction of node pairs actually have an edge between them. Nonetheless, they may be related due to a composition of simple edges: “A” is related to “X”, and “X” is related to “B”.

In this case, the relationship is encapsulated as a path in the graph. If the nodes in a complex network represent people, the relationship between two people is often multi-faceted. For example, “A” and “B” have the same manager and the same dentist. In addition, the paths connecting two people may not be node-disjoint; for instance, the dentist may also be the sister of “A”, or may be dating the brother of “A”.Representing the real-life relationship between two nodes in a graph using a single path is inherently limiting. Any automated mechanism for selecting the most important path can make mistakes. Further, there may not be one critical path. For example, two people who have written papers together with many co-authors (as opposed to a single co-author) can have many relationships in a social network graph through those co-authors.

A primary requirement for understanding complex networks is the identification of “good” paths between two nodes. A “good” path is one that represents a high-quality, true connection path between the two nodes rather than a circumstantial connection between the two nodes. For example, person A and person B may both know person C and person D. However, person C is a famous person who interacts with thousands of people by nature of their fame. Person D is a good friend of both person A and person B. Clearly, the path from person A to person B through person D is the best “good” path.

A conventional technique for choosing “good” paths comprises determining the shortest distance between node A and node B. While useful for many applications, this technique does not capture a notion of “best path” in complex networks. As in the example above, the path length from person A to person B through either person C or person D is of the same “length”, i.e., both paths comprise one intermediate person (path A-C-B and path A-D-B). However, person C represented as a node in a social network graph has many edges emanating from the node, one edge for each person connected to person C. Consequently, the path through person D is intuitively preferred but is not captured by a traditional shortest path computation. For further detail on distance path computation in selecting “goodness,” reference is made to the following two references: D. Liben-Nowell and J. Kleinberg, “The link prediction problem for social networks,” In Proc. CIKM, 2003; and C. R. Palmer and C. Faloutsos, “Electricity based external similarity of categorical attributes.” PAKDD 2003, April-May 2003.

Another conventional technique for choosing “good” paths comprises determining a maximum flow criterion. If utilizing the maximum flow criterion, the relationship or edge weights represent a maximum flow on an edge. Each node generates a unit of flow; this unit of flow is divided among all the paths radiating from the node. Consequently, a path radiating from a famous person with many connections has less flow than a path radiating from a person with few connections.

Returning to the example of person A and person B, suppose person A is a friend of person E while person B is a cousin of person F. Person E and person F are members of the same club. Consequently, a path can further be made from person A to person B through person E and person F (path A-E-F-B). If person E, person F, and person C have no other edges, then the flow from person A to person B through person C (path A-C-B) or through the combination of person E and person F (path A-E-F-B) is equivalent. However, the shorter path through person C (path A-C-B) is a better path because social relationships tend to blur with distance. Consequently, although useful for many applications, both shortest paths and network flow models fail to adequately capture the notion of a “good” path in complex networks.

Another approach to analyzing complex networks involves community detection. While useful in some applications, reporting a “community” of two remotely related nodes requires the use of a tremendous number of allowable edges. Further, a method is needed that allows analysis of the community itself as well as the persons or nodes within the community. For further detail on community detection, reference is made to the following three references: D. Gibson, J. Kleinberg, and P. Raghavan, “Inferring web communities from link topology,” In Ninth ACM Conference on Hypertext and Hypermedia, pages 225-234, New York, 1998; G. Flake, S. Lawrence, C. L. Giles, and F. Coetzee, “Self-organization and identification of web communities,” IEEE Computer, 35(3), March 2002; and M. Girvan and M. E. J. Newman, “Community structure in social and biological networks,” Applied Mathematics, PNAS, Jun. 11, 2002, vol. 99, no. 12, pp. 7821-7826.

What is therefore needed is a system, a service, a computer program product, and an associated method for determining one or more “good” paths between two nodes in a graph in a manner that models interactions in a complex network. The need for such a solution has heretofore remained unsatisfied.

### SUMMARY OF THE INVENTION

The present invention satisfies this need, and presents a system, a service, and an associated method (collectively referred to herein as “the system” or “the present system”) for extracting in real time from an undirected, edge-weighted graph a connection subgraph that best captures the connections between two nodes of the graph. The present system models the undirected, edge-weighted graph as an electrical circuit, forming an electrical graph model. The present system further solves for a relationship between two nodes in the undirected edge-weighted graph based on electrical analogues in the electric graph model.

The connection subgraph is a subgraph of a large graph such as, for example, a social network, that best captures the relationship between two nodes (e.g., people). The present system optionally accelerates the computations to produce approximate, high-quality connection subgraphs in real time on very large graphs (e.g., those that will not fit in memory or are too large to process in their entirety).

The present system comprises a solution to the requirement of finding a connection subgraph H with the following constraints. Given an edge-weighted undirected graph G, node s and node t from G, and an integer budget b, the present system finds a connection subgraph H. The connection subgraph H is constrained to the integer budget of at most b nodes that comprises node s, node t, and a collection of paths from node s to node t that maximizes a “goodness” function g(H).

The constraint on the integer budget b by the present system is motivated by limitations on visualization of graphs (e.g., b≦100 nodes). The goodness function g(H) represents the “goodness” of the connection subgraph H. The present system utilizes a particular goodness function g(H) that is tailored to produce connection subgraphs H that capture salient aspects of a relationship between node s and node t. In one embodiment, the budget b on nodes can be replaced with a budget b on edges as required by the problem domain.

The present system is domain independent. For exemplary purposes, the present system is described with respect to “named-entity” extraction processors to derive a “name graph” from the World Wide Web. In the name graph, the nodes represent names of people. Furthermore, there is an edge of weight w between two names if the names appear in close proximity on w different web pages. The “name graph” is a valuable resource because the present system can identify patterns, outliers, and connections in the name graph.

The present system uses “connection graphs”,localized graphs that convey much information about the relationship between a pair of nodes. Further, the present system uses “delivered current” as a method to measure the goodness of the “connection graph”. The present system gives higher preference to paths that are more likely to occur in a random walk from a source node to a destination node with the addition of a “universal sink” node.

The present system uses a display generator comprising a display graph generation processor. The display graph generation processor is a dynamic-programming processor that attempts to find the best “connection graph” with a budget of b nodes. The present system further comprises an optional candidate graph generator. The candidate graph generator comprises fast heuristics that can handle huge, disk-resident graphs, in near-real time, while still maintaining high accuracy.

The connection sub-graphs created by the present system can be used to describe relationships between persons or between any pair of named entities, e.g., a person and a company, or a company and a product. Connection subgraphs created by the present system are useful in a wide variety of interactive data exploration systems. The present system can be used to determine relationships between any two similar or dissimilar objects with relationships that can be described in a graph.

Using connection subgraphs, the present system can determine relationships between people for a variety of applications. These relationships can be used, for example, in a dating service to determine likely matches between people. The relationships can be used in law enforcement to identify criminal activity between criminals or terrorists and to identify a likely structure for a criminal gang or terrorist group. The relationships can further be used to locate persons with skills similar to an employee that is leaving a company.

Using connection subgraphs, the present system can determine relationships between objects such as companies. The analysis of relationships between companies may be used in a wide variety of applications. For example, the relationships can be used by financial analysts in analyzing performance of companies for stock portfolios or locating companies that are a good investment. The relationships can be used to locate companies with a product or skill set that meets a specific need. These relationships can further be used by various government agencies to identify and prosecute companies that are engaging in illegal activities such as stock manipulation, etc. Further, the present system can determine which companies are most likely to influence a company; this information is useful in negotiations.

The present system can be used in many applications in the medical field such as, for example, determining interactions between objects such as chemicals or drugs and cells. The present system can determine relationships between genes for use in gene mapping or other gene research. Further, the present system can be used to determine a path of transmission of a disease.

The present system can be used in web applications to identify web sties most like one or more specified web sites. Further, the present system can be used to better locate persons with like interest on the Internet. In addition, the present system can improve search results by selecting those results that present the best likeness to the search request.

The present system may be embodied in a utility program such as an optimal path selection utility program. The present system provides means for the user to identify a graph, database, or other set of data as input data from which an optimal path may be selected by the present system. The present system also provides means for the user to specify a set of nodes between which an optimum path is desired. The present system further provides means by which a user may select one node and request a set of nodes to which optimal paths are formed from the selected node. A user specifies the input data and the set of nodes or the one node and then invokes the optimal path selection utility program to search and find such optimal paths. In an embodiment, the data to be analyzed is provided by the present system.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which an optimal path selection system of the present invention can be used;

FIG. 2 is a block diagram of the high-level architecture of the optimal path selection system of FIG. 1;

FIG. 3 is an exemplary undirected, edge-weighted graph illustrating a method of operation of the optimal path selection system of FIGS. 1 and 2;

FIG. 4 is comprised of FIGS. 4A and 4B and represents an electrical graph model of the exemplary undirected, edge-weighted graph of FIG. 3 as generated by the optimal path selection system of FIGS. 1 and 2;

FIG. 5 is a process flow chart illustrating a method of operation of the optimal path selection system of FIGS. 1 and 2; and

FIG. 6 is a process flow chart illustrating a method of operation of the optional candidate generator of the optimal path selection system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Node: An arbitrary entity, representing a person, a group of people, a machine, a website, a species, a cell, a gene, or any other object for which a relationship to another node can be formed.

Edge: A pair of nodes, representing a relationship between the associated entities.

Undirected edge: An edge is considered undirected if the order of the nodes is unimportant.

Weighted edge: An edge may be weighted by associating a number with the pair of nodes. This weight is often used to represent the relative strength of the relationship.

Graph: A set of nodes and a set of edges.

Undirected graph: A graph in which the edges are undirected.

Weighted graph: A graph in which the edges are weighted.

Subgraph: A subgraph H of a given graph G includes a subset of the nodes of G together with a subset of edges from H. The edges of the subgraph may only connect nodes in the subgraph.

Connection subgraph: A subgraph of a given graph that represents the “best set of paths” between two nodes of the graph, as measured by a goodness function.

Current: A flow of electrical charge. This current can be determined from voltages and conductance using Ohm's law and Kirchoff's law.

Goodness Function: A function that measures the quality of connection of a subgraph containing two nodes. Examples include the total weight of edges, and the number of paths.

High-degree Node: A node in a graph with a number of neighbors in excess of a predetermined threshold.

Internet: A collection of interconnected public and private computer networks that are linked together with routers by a set of standards protocols to form a global, distributed network.

Low-degree Node: A node in a graph with a number of neighbors below a predetermined threshold.

World Wide Web (WWW, also Web): An Internet client—server hypertext distributed information retrieval system.

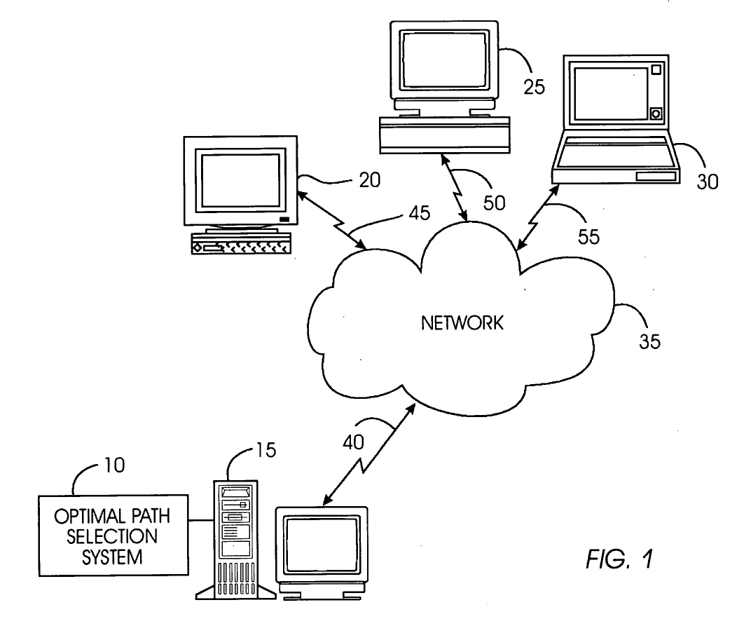

FIG. 1 portrays an exemplary overall environment in which a system, a service, a computer program product, and an associated method (“the system 10”) for finding an optimal path among a plurality of paths between two nodes in an edge-weighted graph according to the present invention may be used. System 10 includes a software programming code or computer program product that is typically embedded within, or installed on a host server 15. Alternatively, system 10 can be saved on a suitable storage medium such as a diskette, a CD, a hard drive, or like devices. While the system 10 will be described in connection with the WWW, the system 10 can be used with a stand-alone database of terms that may have been derived from the WWW or other sources.

Users, such as remote Internet users, are represented by a variety of computers such as computers 20, 25, 30, and can access the host server 15 through a network 35. Computers 20, 25, 30 each comprise software that allows the user to interface securely with the host server 15.

The host server 15 is connected to network 35 via a communications link 40 such as a telephone, cable, or satellite link. Computers 20, 25, 30, can be connected to network 35 via communications links 45, 50, 55, respectively. While system 10 is described in terms of network 35, computers 20, 25, 30 may also access system 10 locally rather than remotely. Computers 20, 25, 30 may access system 10 either manually, or automatically through the use of an application.

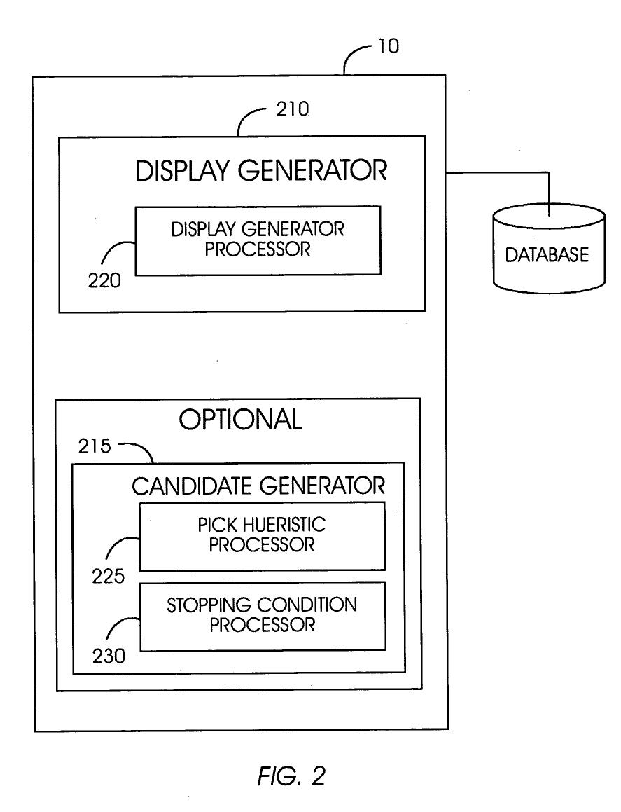

FIG. 2 is a top-level hierarchy of system 10. System 10 generates a graph that represents data derived from a database 205. System 10 comprises a display generator 210 and an optional candidate generator 215. The display generator 210 comprises a display generator processor 220 for selecting an optimum path between two nodes of interest in the graph. The candidate generator 215 comprises a pickHeuristic processor 225 and a stopping condition processor 230. The pickHeuristic processor 225 determines a subgraph of the graph that contains most of the interesting connections between the two nodes of interest in the graph. The stopping condition processor 230 determines when the subgraph is sufficiently large enough to comprise most of the interesting connections between the two nodes of interest in the graph.

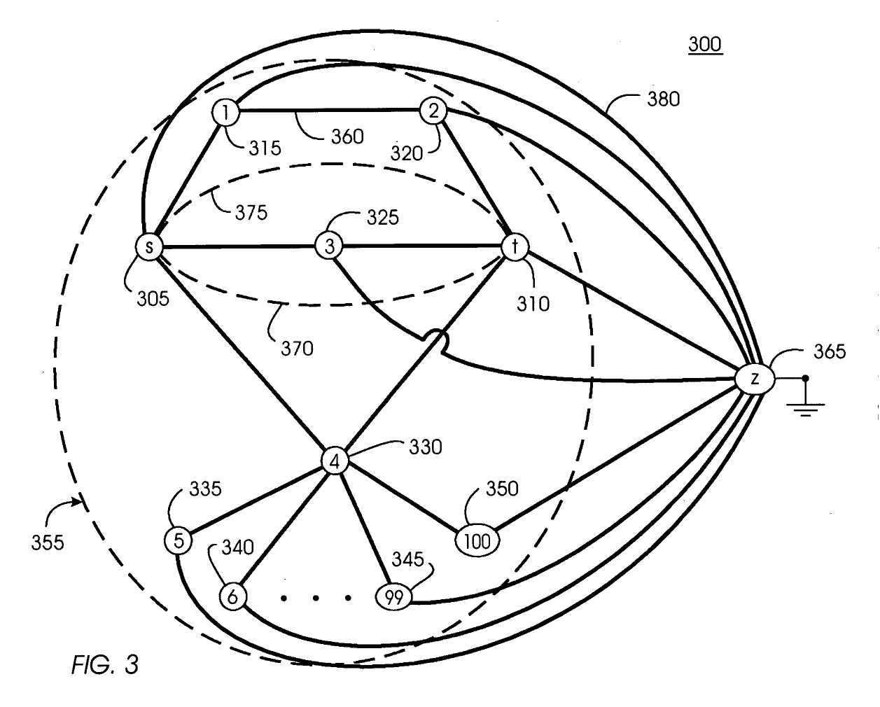

FIG. 3 illustrates an undirected edge-weighted graph 300 (further referenced herein as graph 300) analyzed by system 10. Graph 300 comprises a source node s, 305, (also referenced herein as node s, 305) and a destination node t, 310 (also referenced herein as node t, 310). Graph 300 further comprises a node 1, 315, a node 2, 320, a node 3, 325, a node 4, 330, a node 5, 335, a node 6, 340, through a node 99, 345, and a node 100, 350 (collectively referenced herein as nodes 355). To determine a best “good” path from node s, 305, to node t, 310, system 10 models graph 300 as an electrical graph model, a electrical circuit comprising a network of resistors. Reference is made to P. Doyle and J. Snell, “Random walks and electric networks,” volume 22, Mathematical Association America, New York, 1984.

Let G(V,E) denote the undirected edge-weighted graph 300, and let C(e) denote the weight of an edge e such as edge 360. System 10 models graph 300 as an electrical network in which each edge e represents a resistor with conductance C(e). System 10 selects a connection subgraph between two nodes that can deliver as many units of electrical current as possible. Table 1 lists the symbols and definitions used in the modeling and analysis of an undirected edge-weighted graph such as graph 300 as an electrical circuit.

TABLE 1
Symbols and definitions for terms used in the modeling and analysis
of an undirected edge-weighted graph as an electrical circuit.

| Symbol | Definition |
|---|---|
| G(V, E) | An undirected, edge-weighted graph |
| V | A set of nodes |
| E | A set of edges |
| N | Number of nodes |
| E | Number of edges |
| deg(u) | Degree of node u |
| V(u) | Voltage of node u |
| I(u, v) | Current on edge (u, v) |
| C(u, v) | Conductance of edge (u, v) |
| C(u) | $\begin{matrix}= {\sum }_{v} C ( u , v ) \\ Conductance of node u\end{matrix}$ |
| Î(P) | Delivered current over “prefix path” P |
| CF(H) | Flow captured by subgraph H |
| s | Source node |
| t | Destination node |
| z | “Universal Sink” node |

System 10 models in graph 300 the application of a voltage of +1 volt to the node s, 305, and ground (0 volts) to node t, 310. In general, the current flow from node u to node v is I(u, v); V(u) denotes the voltage at node u. Utilizing two laws well known in the art of electric circuits, Ohm's law provides the following equation:
∀u, v:I(u, v)=C(u, v)(V(u)−V(v)) (1)
and Kirchoff's current law provides the following equation:

$$∀ v \neq s , t : {\sum }_{u} I ( u , v ) = 0 \qquad ( 2 )$$

Equation (1) and equation (2) uniquely determine all the voltages and currents in graph 300 induced by applying voltage to node s, 305, while grounding node t, 310. The voltage at each node u and current through path (u, v) are determined from equation (1) and equation (2) as the solution to a linear system:

$$\begin{matrix}V ( u ) = {\sum }_{v} V ( v ) C ( u , v ) / C ( u ) & & & ∀ u \neq s , t\end{matrix} \qquad ( 3 )$$

(where

$$C ( u ) = {\sum }_{v} C ( u , v )$$

is the total conductance of edges incident to the node u), with boundary conditions:
V(s)=1, V(t)=0 (4)

The voltages and currents of the resulting network can be viewed as quantities related to random walks along graph 300. For example, consider an electrical network defined by equation (3) and equation (4). Consider also all random walks on graph 300 that:
(a) Start from the destination node t, 310;
(b) End on the source node s, 305;
(c) Follow an edge (u, v) with a probability that is proportional to its conductance (C(u, v)); and
(d) Do not revisit the destination node t, 310. (Zero or more intermediate visits to the source node s, 305, are permitted).
   Consequently, the electric current I(u, v) is proportional to the net number of times that such walks traverse the edge (u, v). Reference is made to P. Doyle and J. Snell. “Random walks and electric networks,” volume 22, Mathematical AssociationAmerica, New York, 1984.

System 10 further refines the use of an electrical graph model for graph 300 by utilizing a ground node as a universal sink node z, 365 (also referenced herein as node z, 365). The formulation of current flow is a measure of goodness for a connection graph, namely the subgraph of a given size that maximizes the total current

$${\sum }_{v} I ( v , t )$$

flowing into the destination node. Without the universal sink node z, 365, a path 370 from node s, 305, to node t, 310, through node 3, 325 carries the same current as a path 375 from node s, 305, to node t, 310, through node 2, 315, and node 2, 320.

System 10 makes path 370 more favorable than path 375 by connecting each of the nodes 355 to node z, 365, through a sink edge such as sink edge 380. Node z, 365, is grounded such that:
V(z)=0. (5)
Each sink edge such as sink edge 380 comprises a conductance such that:

$$C ( u , z ) = α {\sum }_{w \neq z} C ( u , w ) \qquad ( 6 )$$

for some parameter α>0. Node z, 365, absorbs a positive portion of the current that flows into any of the nodes 355 in a manner similar to a “tax”. Consequently, node z, 365, penalizes a node with high degree such as node 4, 330 (i.e., a node with many edges). Node z, 365, taxes a high-degree node not only directly, but many times indirectly through the neighbors of the high-degree node. Furthermore, node z, 365, heavily penalizes long paths because the tax is applied repeatedly for each of the nodes 355 that the path comprises.

System 10 utilizes the concept of delivered current to determine “good” paths in graph 300. System 10 forbids random walks from reaching the universal sink node z, 365. System 10 then determines the paths that carry the most current. More accurately, system 10 wants paths that, after the “taxation” by the universal sink node z, 365, are responsible for delivering high current to the node t, 310.

System 10 utilizes a goodness function g(H) that is the total delivered current that a chosen subgraph H carries from node s, 305, (the source node) to node t, 310 (the destination node) after repeated taxations by node z, 365 (the universal sink node). To locate good connection subgraphs utilizing the goodness function g(H), system 10 calculates the currents on graph 300. System 10 then extracts a subgraph that carries high current to node t, 310, in a process called display generation.

Calculating current flows with a universal sink such as node z, 365, is feasible even for very large graphs, but not in an interactive environment. In one embodiment, system 10 utilizes the candidate generator as a preprocessing step. The candidate generator quickly produces a moderate-sized graph by removing nodes and edges that are too remote from node s, 305, and node t, 310, to influence a solution.

The display generator 210 takes as input the weighted, undirected graph G(V,E) such as graph 300 and the flows I(u,v) on all (u,v) edges, and produces as output a small, unweighted, undirected graph G_{disp}(≡H) suitable for display to a user. Typically, G_{disp} has approximately 20 to 30 nodes. The goodness measure is the “delivered current” that the chosen subgraph G_{disp} carries from a source node such as node s, 305, to a destination node such as node t, 310. Each atomic unit of flow (i.e., each electron) travels along a single path. Consequently, system 10 can decompose the flow into paths, allowing a formal notion of current delivered by a subgraph. To determine the current delivered by a subgraph, system 10 defines a node as v being downhill from a node u (u→_{d} v) as follows:
u(u→_{d} v) if I(u, v)>0 or, identically, V(u)>V(v).
The total current out-flow from node u is:

$${I}_{out} ( u ) = {\sum }_{\{ v \vert u \to v \}} I ( u , v ) .$$

System 10 defines a prefix path as any downhill path P that starts from a source node such as node s, 305; i.e.:
P=(s=uₗ, . . . uᵢ) where uⱼ→_{d} uⱼ₊₁
A prefix path has no loops because of the downhill requirement. Consequently, the delivered current Î(P) over a prefix-path P=(s=uₗ, . . . uᵢ) is the volume of electrons that arrive at uᵢ from a source node such as node s, 305, strictly through P. System 10 defines Î( ) as follows, beginning with a single edge as base case:

$$\begin{matrix}\hat{I} ( s , u ) = I ( s , u ) \\ \hat{I} ( s = {u}_{1} , K , {u}_{i} ) = \hat{I} ( s = {u}_{1} , K , {u}_{i - 1} ) \frac{I ( {u}_{i - 1} , {u}_{i} )}{{I}_{out} ( {u}_{i - 1} )} .\end{matrix}$$

To estimate the delivered current to a node uᵢ through path P, system 10 pro-rates the delivered current to a node uᵢ₋₁ proportionately to the outgoing current I(uᵢ₋₁, uᵢ). System 10 defines captured flow CF(H) of a subgraph H of G(V,E) as the total delivered current summed over all source-sink prefix paths that belong to H:

$$CF ( H ) ≡ g ( H ) = {\sum }_{P = ( s , K , t ) ∈ H} \hat{I} ( P )$$

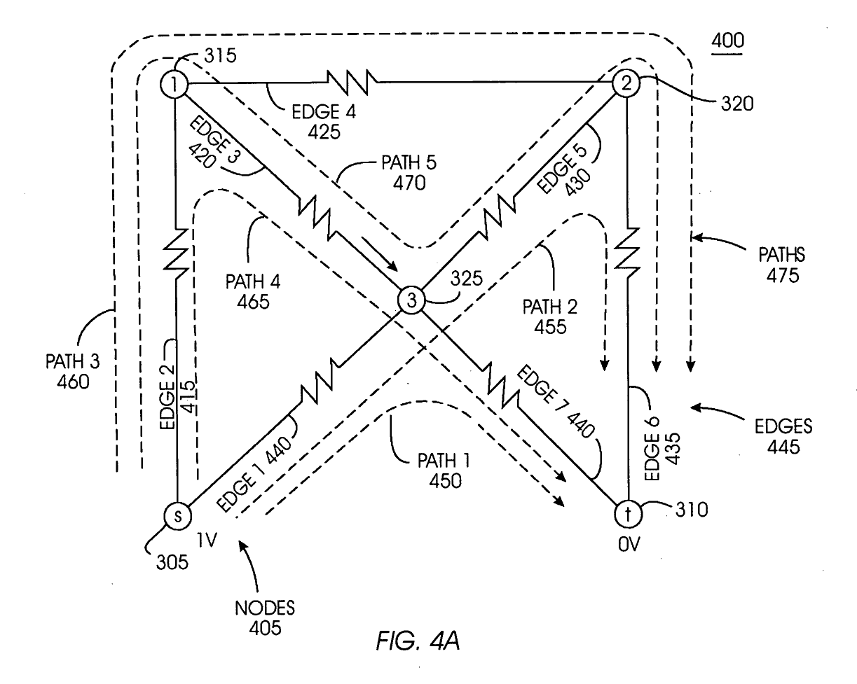

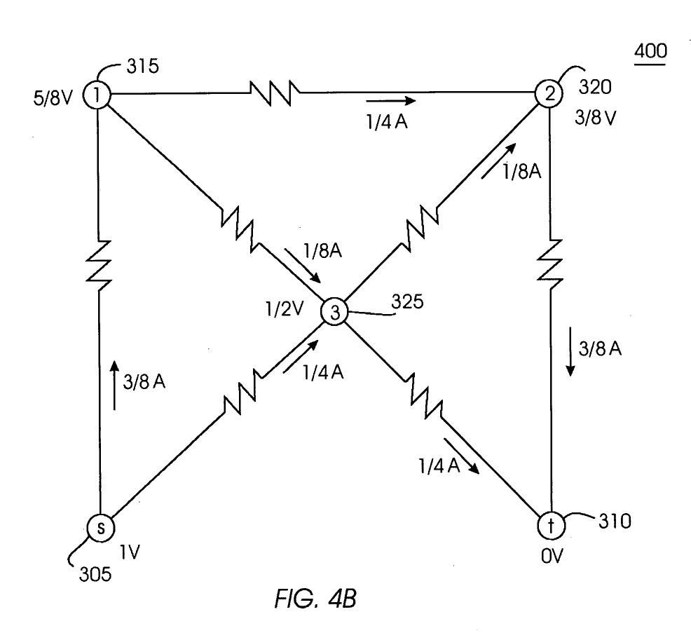

Graph 300 of FIG. 3 illustrates the operation of system 10, with further reference to a subgraph 400 of graph 300 in FIG. 4 (FIGS. 4A, 4B). Subgraph 400 comprises node s, 305, node t, 310, node 1, 315, node 2, 320, and node 3, 325 (collectively referenced herein as nodes 405). Subgraph 400 further comprises an edge 1, 410, an edge 2, 415, an edge 3, 420, an edge 4, 425, an edge 5, 430, an edge 6, 435, and an edge 7, 440 (collectively referenced herein as edges 445). For simplicity of exposition, and without loss of generality, node z, 365, of graph 300 is removed from this analysis by setting the conductance value a equal to zero, inserting infinite resistance in each edge such as edge 380 to node z, 365. System 10 sets the voltage of node s, 305, to 1 V. System 10 further sets the voltage at node t, 310, to 0 V. The conductance of each of the edges 445 is set to 1 for exemplary purposes, implying a resistance of 1 ohm for each of the edges 445 between each of the nodes 405.

There are five downhill source-to-sink paths in subgraph 400. Path 1, 450, comprises node s, 305, edge 1, 410, node 3, 325, edge 7, 440, and node t, 310. Path 2, 455, comprises node s, 305, edge 1, 410, node 3, 325, edge 5, 430, node 2, 320, edge 6, 435, and node t, 310. Path 3, 460, comprises node s, 305, edge 2, 415, node 1, 315, edge 4, 425, node 2, 320, edge 6, 435, and node t, 310. Path 4, 465, comprises node s, 305, edge 2, 415, node 1, 315, edge 3, 420, node 3, 325, edge 7, 440, and node t, 310. Path 5 comprises node s, 305, edge 2, 415, node 1, 315, edge 3, 420, node 3, 330, edge 5, 430, node 2, 320, edge 6, 435, and node t, 310. Path 1, 450, path 2, 455, path 3, 460, path 4, 465, and path 5, 470, are collectively referenced as paths 475.

The resulting voltages are shown in FIG. 4B for nodes 405. These voltages induce currents along each of the edges 445 as shown in FIG. 4B. Paths 475 with their delivered current are listed in Table 2. The path that delivers the most current (and the most current per node) is path 1, 450. System 10 computes the ⅖ A delivered by path 1, 450, by determining that, of the 0.5 A that arrives at node 3, 330, on edge 1, 410, ⅕ of the 0.5 A departs towards node 2, 320, while ⅘ of the 0.5 A departs towards node t, 310. The total current for path 1, 450, is then ⅘*0.5 A=⅖ A.

TABLE 2
Current in paths of FIG. 4 induced by an applied voltage of 1 V.

| Path | Current | |
|---|---|---|
| Path 1 | ⅖ | A |
| Path 2 | ¼ | A |
| Path 3 | 1/10 | A |
| Path 4 | 1/10 | A |
| Path 5 | 1/40 | A |

Using the display generator processor 220, system 10 determines a subgraph from an edge-weighted undirected graph G(VE) such as graph 300 that maximizes the captured flow over all subgraphs of its size. In general, system 10 initializes an output graph to be empty. Next, system 10 iteratively adds end-to-end paths (i.e., from a source node such as node s, 305, to a destination node such as node t, 310) to the output graph. Since the output graph is growing, a new path may comprise nodes that are already present in the output graph; system 10 favors such paths. Formally, at each step the display generator processor adds the path with the highest marginal flow per node. That is, system 10 chooses the path P that maximizes the ratio of flow along the path, divided by the number of new nodes that are added to the output graph.

System 10 computes the delivered current given above using dynamic programming, modified to compute the path with maximum current. Dynamic programming utilizes a dynamic programming table, D_{v,k}, in the context of a partially built output graph. In general, the dynamic programming table, D_{v,k}, is defined as the current delivered from a source node (s) to a node (v) along the prefix path P=(s=uₗ, . . . , uₗ=v) such that:
1. P has exactly k nodes not in the present output graph
2. P delivers the highest current to node v among all such paths that end at node v.

To compute D_{v,k}, system 10 exploits the fact that the electric current flows I(*,*) form an acyclic graph. System 10 arranges the nodes into a sequence uₗ=s,u₂,u₃, . . . , t=uₙ such that if node uⱼ is downhill from uᵢ(uᵢ→_{d} uⱼ) then uⱼ follows uᵢ in the ordering (i<j) of system 10. That is, the nodes are sorted in descending order of voltage; consequently, electric current always flows from left to right in the ordering. System 10 fills in the table D_{v,k} in the order given by the topological sort above, guaranteeing that system 10 has already computed D_{u,*} for all u→_{d} v when D_{v,k} is computed.

The following pseudocode illustrates a method of the display graph generator in computing the entries of D_{v,k}:
Initialize output graph G_{disp} to be empty
Let P be the maximum allowable path length (trivially, the target size of the display graph)
While output graph is not big enough:
   For i←[1 . . . |G|]:
      Let v=uᵢ
      For k←[2 . . . P]:
         If v is already in the output graph
            k″=k
         else k″=k−1
         Let D_{v,k}=max_{u|u→}_{_{d}}ᵥ(D_{u,k},I(u, v)/Iₒᵤₜ(u))
   Add the path maximizing D_{t,k}/k,k≠0

The fraction of flow arriving at u that continues to v is represented by I(u,v)/Iₒᵤₜ(u). Multiplying I(u,v)/Iₒᵤₜ(u) by D_{u,k′} gives the total flow that can be delivered to v through a simple path. The path maximizing the measure of goodness, g(H), is then the path that maximizes D_{t,k}/k over all k≠0. This path can be computed by tracing back the maximal value of D from a destination node such as node t, 310, to a source node such as node s, 305.

As mentioned previously, computing the voltages and currents on a huge graph can be very expensive. To present results quickly, system 10 utilizes the candidate generator 215 in an optional precursor step. The candidate generator 215 extracts a candidate graph that is a subgraph of the original graph. The candidate generator 215 comprises an extraction processor. The extraction processor quickly produces from the original graph a subgraph that contains the most important paths. This subgraph is then treated as the full graph for the remainder of the processor: current flows are computed as usual for the candidate graph and the display generator 210 is applied to the result.

Formally, the candidate generator 215 takes a source node such as node s, 305, and a destination node such as node t, 310, in the original graph G(V,E), and produces a much smaller graph (G_{cand}) by carefully growing neighborhoods around a source node such as node s, 305, and a destination node such as node t, 310. The focus of the expansion is on recall rather than precision; during display generation system 10 removes any spurious regions of the graph. When using the candidate generator 215, system 10 attains performance close to optimal with a latency that is orders of magnitude smaller than with the display generator 210 alone.

The candidate generator 215 strategically expands the neighborhoods of a source node such as node s, 305, and a destination node such as node t, 310, until there is a significant overlap. As the processor proceeds, it expands the source node s, 305, discovering other candidate nodes that it may choose to expand later.

System 10 defines D(s) as a first set of nodes discovered through a series of expansions beginning at a source node such as node s, 305, where node s, 305, is the root of all nodes in D(s). System 10 further defines E(s) as the set of expanded nodes within D(s). The expanded nodes E(s) have been accessed in a data structure and the neighbors of E(s) are now known. Likewise, P(s) is a set of pending nodes within D(s) that have not yet been expanded.

System 10 defines D(t) as a second set of nodes discovered through a series of expansions beginning at a destination node such as node t, 310, where node t, 310, is the root of all nodes in D(t). System 10 further defines E(t) as the set of expanded nodes within D(t). The expanded nodes E(t) have been accessed in a data structure and the neighbors of E(t) are now known. Likewise, P(t) is the set of pending nodes within D(s) that have not yet been expanded. By expanding a node whose root is either a source node such as node s, 305, or a destination node such as node t, 310, D(s) is disjoint from D(t) since each node is discovered only once. For edge-weighted graphs, system 10 uses C(u, v) as the weight of the edge from a node u to a node v. System 10 further defines deg(u) to be the degree (number of neighbors) of node u.

Input to the candidate generator 215 is a graph G(V,E) that is edge-weighted and undirected, a source node such as node s, 305, and a destination node such as node t, 310. The pickHeuristic processor 225 of the candidate generator 215 then finds a G_{cand} ⊂ G(E,V)that is much smaller than G(V,E) but contains most of the interesting connections between a source node such as node s, 305, and a destination node such as node t, 310.

A high level pseudocode of pickHeuristic processor 225 of the candidate generator 215 is as follows:

```
Set P(s) = {s} and P(t) = {t}.
While not stoppingCondition( ):
    // pick v, the most promising node of P(s) ∪ P(t)
    ν [symbol] pickHeuristic( )
    // and expand it
    Let r be the root of v
    Expand v, moving it from P(r) to E(r)
    Add all new neighbors of v to P(r)
```

The details of the pickHeuristic processor 225 of the candidate generator 215 lie in the process of deciding which node to expand next and when to terminate expansion. The candidate generator 215 expands carefully selected unexpanded nodes chosen by the pickHeuristic processor 225 until a stopping condition determined by the stoppingCondition processor 230 is reached. In effect, the pickHeuristic processor 225 strives to suggest a node for expansion, estimating how much delivered current this node carries. Thus, the pickHeuristic processor 225 favors nodes that:
(a) Are close to a source node such as node s, 305, or a destination node such as node t, 310;
(b) Exhibit strong connections (high conductance); and
(c) Exhibit a low degree with few neighbors (as opposed to node 4, 330 of FIG. 3, for example).

The pickHeuristic processor 225 chooses the next node to expand during candidate generation. The candidate generator 215 does this within a framework based on a distance function for a candidate graph being processed. Among the pending nodes, the candidate generator 215 always chooses for expansion the one that is closest to its root, in some sense. There are several reasonable ways to define closeness. In one embodiment, the candidate generator 215 introduces a (possibly asymmetric) length on edges and defines the distance between node u and node v as the minimum over all paths from node u to node v of the sum of the lengths of the edges along the path. Consequently, the decision about what to expand next is encoded as a weighted, directed, graph distance.

The candidate generator 215 comprises definitions of the length of an edge from node u to node v, based on flags that can each be set two ways. Generally, the distance is given by f(n/d), where these exemplary flags control the values of f, n, and d, as follows:
Numerator: If the distance is degree-weighted then n=deg²(u), otherwise n=deg(u).
Denominator: If the distance is count-weighted then d=C(u, v)², otherwise d=C(u, v)
Multiplicative: If the distance is multiplicative then f(x)=log(x), else f(x)=x. Consequently, a basic distance function is d(u)/C(u, v), and the degree-weighted, count-weighted, multiplicative distance function is log(deg²(u)=C(u, v)²).

The distance function of the candidate generator 215 treats lower-degree nodes as closer. Consequently, the expansion performed by the candidate generator 215 discovers longer paths through low-degree nodes rather than shorter paths through high-degree nodes. However, G(V,E) is weighted such that nodes with high weight edges are considered close together because they have a relatively strong connection. The term C(u, v), corresponds to the weight of the edge.

The candidate generator 215 uses multiplicative distance rather than traditional additive distance. By taking the logarithm of the edge weight and adding these values along a path, the candidate generator 215 computes the logarithm of the product. Since the logarithm is monotonically increasing, comparisons of path lengths provide the same result as for multiplication of edge weights.

The candidate generator 215 uses multiplication for the following reason. Consider a path in which all edges have weight 1. If the degrees of vertices along the path are d₁, d₂, . . . , dₖ, the number of vertices reachable by expanding all paths of the given length in a tree with branching factor dᵢ at level i is

$$R = {\prod }_{i} {d}_{i} .$$

If node z, 365, is uniformly located among all such nodes, the probability of reaching node z, 365, is proportional to R. Consequently, a lower multiplicative distance represents nodes that are “closer” to the root in the sense that a sequence of expansions with the given degree reaches a smaller set of vertices.

The stoppingCondition processor 230 puts limits on the size of the output graph G_{cand} such as, for example, count of expansions, count of distinct nodes discovered, etc. The candidate generator 215 defines three thresholds for termination by the stoppingCondition processor 230; the candidate generator 215 stops as soon as any threshold is exceeded. The stoppingCondition processor 230 uses a threshold on total expansions to limit the total number of disk accesses. In addition, the stoppingCondition processor 230 uses a larger threshold on discovered nodes even if those nodes have not yet been expanded, to limit memory usage. Furthermore, the stoppingCondition processor 230 uses a threshold on number of cut edges (edges between D(s) and D(t)), as a measure of the connectedness of the set of nodes with the universal sink node z, 365, as a root.

The candidate generator 215 runs until its termination conditions are met, performing a single disk seek per expansion. The calculation of currents on a network with a universal sink node such as node z, 365, requires the solution of the linear system as illustrated by equation (3) and equation (4). For a graph with N nodes and E edges, calculation of currents can be done by direct methods in O(N₃) operations, but iterative methods often perform much better on sparse graphs. For a graph with E edges, system 10 performs O(E) operations per iteration where the number of iterations depends on the gap between the largest eigenvalue and the second largest eigenvalue. The display generator 210 takes O(ekb) time, and O(vk) space, where v is the number of nodes in the input graph, e is the number of edges, k is the maximum length of any allowed path from a source node such as node s, 305, to a destination node such as node t, 310, and b is the budget, or desired number of nodes in the display graph.

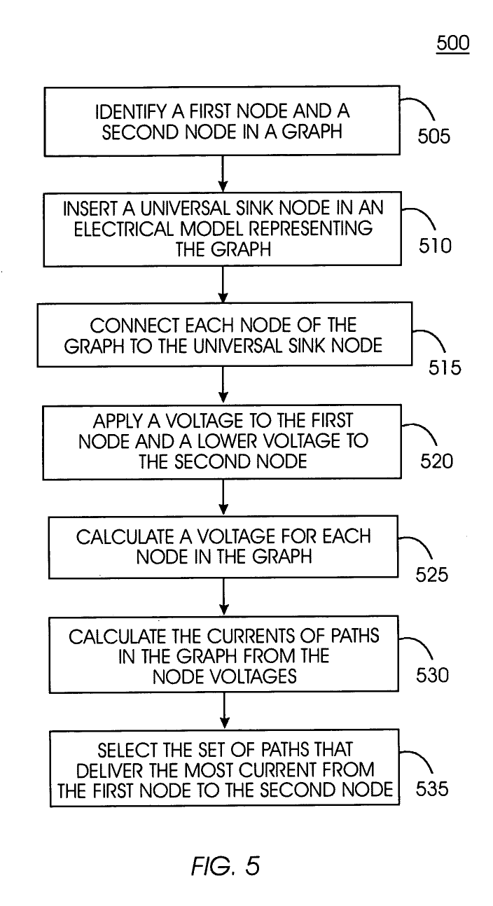

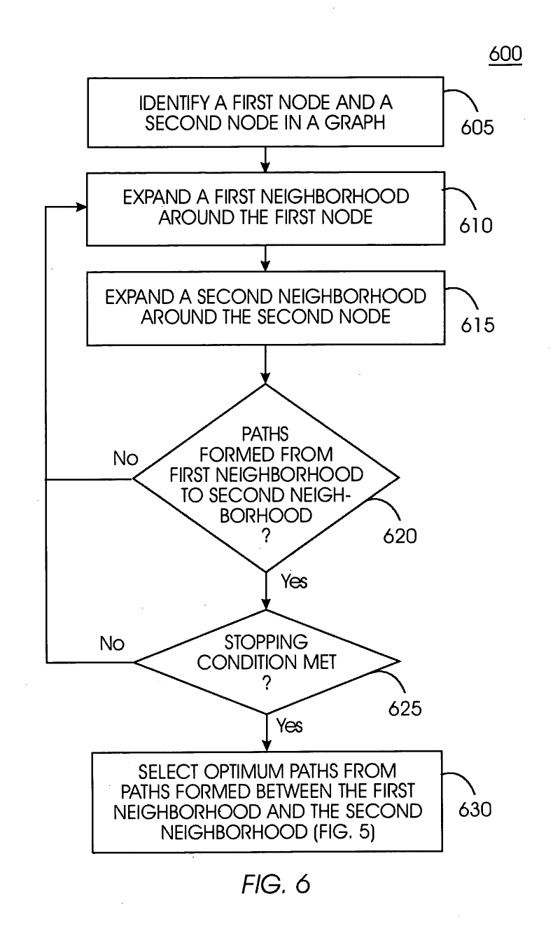

FIG. 5 illustrates a method 500 of operation of system 10, with further reference to FIG. 3. System 10 identifies in a graph a first node such as node s, 305, and a second node such as node t, 310, corresponding to user input (step 505). System 10 inserts a universal sink node such as node z, 365, in an electrical graph model representing the graph (step 510) and connects each node of the graph to the universal sink node (node z, 365) (step 515). System 10 applies a voltage to the first node (node s, 305) and a lower voltage to the second node (node t, 310) (step 520). System 10 calculates a voltage for each node in the graph (step 525). System 10 then calculates the currents of paths in the graph from the node voltages (step 530). Analysis by system 10 of paths in the graph yields one or more optimum paths between the first node and the second node based on the current through the paths. System 10 selects the set of paths that deliver the most current from the first node to the second node (step 535); the paths that deliver the most current from the first node to the second node are the optimum paths.

FIG. 6 illustrates a method 600 of operation of system 10 when using the optional candidate generator 215. System 10 identifies in a graph a first node such as node s, 305, and a second node such as node t, 310, corresponding to user input (step 605). The candidate generator 215 expands a first neighborhood around the first node (step 610) and a second neighborhood around the second node (step 615). The first neighborhood comprises a first set of expanded nodes and the edges connecting the first node to the first set of expanded nodes. The second neighborhood comprises a second set of expanded nodes and the edges connecting the second node to the second set of expanded nodes.

As the candidate generator 215 expands the first neighborhood and the second neighborhood, paths from the first node to the second node. The candidate generator 215 determines whether any paths have formed from the first neighborhood to the second neighborhood (decision step 620). If not, the candidate generator 215 further expands the first neighborhood and the second neighborhood, adding nodes and edges. When paths form between the first neighborhood and the second neighborhood, the candidate generator 215 determines whether a stopping condition has been met (decision step 625). If not, expansion of the first neighborhood and the second neighborhood continue (step 610). Otherwise, a candidate graph has been formed and system 10 selects optimum paths from paths formed between the first neighborhood and the second neighborhood following steps 510 through 535 of FIG. 5.

It is to be understood that the specific embodiments of the invention that have been described are merely illustrative of certain applications of the principle of the present invention. Numerous modifications may be made to a system and method for finding an optimal path among a plurality of paths between two nodes in an edge-weighted graph described herein without departing from the spirit and scope of the present invention. Moreover, while the present invention is described for illustration purpose only in relation to the WWW, it should be clear that the invention is applicable as well to, for example, data derived from any source stored in any format that is accessible by the present invention.

1. A method of finding a subgraph that contains at least one optimal path among a plurality of paths between a first node and a second node, comprising:
defining a subgraph between the first node and the second node, wherein the subgraph comprises a plurality of nodes and a plurality of edges connecting the plurality of nodes;
modeling a graph containing the subgraph as an electrical circuit that forms an electrical graph model for simulating an electric current passed along the plurality of paths;
connecting a universal sink node to each of the plurality of nodes in the graph by means of a sink edge, for diverting a fraction of the current passed along the plurality of paths, while favoring a short path over a long path;
selecting the at least one optimal path that meets at least one criterion of a goodness function, wherein the goodness function selects the at least one optimal path from among the plurality of paths that passes a current with a highest amplitude, after the fraction of the current is diverted to the universal sink node; and
adding the plurality of nodes and edges in the at least one optimal path to the subgraph.

2. The method of claim 1, wherein the goodness function selects the at least one optimal path between the first node and the second node by comparing the current passed along the plurality of paths in the electrical graph model.

3. The method of claim 1, wherein the electrical graph model is formed from a plurality of data stored in a data repository.

4. The method of claim 1, wherein the graph comprises an edge-weighted graph.

5. The method of claim 4, wherein at least some of the plurality of edges of the edge-weighted graph are equal.

6. The method of claim 1, further comprising growing a first neighborhood of edges and nodes around the first node.

7. The method of claim 1, further comprising growing a second neighborhood of edges and nodes around the second node.

8. The method of claim 7, further comprising identifying nodes in the second neighborhood that connect with the nodes in the first neighborhood.

9. The method of claim 8, further comprising identifying nodes in the first neighborhood that connect with the nodes in the second neighborhood.

10. The method of claim of claim 9, further comprising determining a point at which paths formed between the first node and the second node from the first neighborhood to the second neighborhood are sufficient for selecting the at least one optimal path.

11. A method for identifying at least one optimum path in a graph, comprising:
specifying a plurality of data from which the graph is formed;
specifying a first selected hode and a second selected node between which the at least one optimum path is expected to exist;
invoking an optimal path selection utility program, wherein the data, the first selected node, and the second selected node are made available to the optimal path selection utility program; and
identifying one or more optimal paths between the first selected node and the second selected node.

12. A system for finding a subgraph that contains at least one optimal path among a plurality of paths between a first node and a second node, comprising:
a subgraph between the first node and the second node, wherein the subgraph comprises a plurality of nodes and a plurality of edges connecting the plurality of nodes;
a display generator for modeling a graph containing the subgraph as an electrical circuit that forms an electrical graph model for simulating an electric current passed along the plurality of paths;
a universal sink node connected to each of the plurality of nodes in the graph by means of a sink edge, for diverting a fraction of the current passed along the plurality of paths, while favoring a short path over a long path; and
the display generator further selects the at least one optimal path that meets at least one criterion of a goodness function, wherein the goodness function selects the at least one optimal path from among the plurality of paths that passes a current with a highest amplitude, after the fraction of the current is diverted to the universal sink node, so that the plurality of nodes and edges are added in the at least one optimal path to the subgraph.

13. The system of claim 12, wherein the goodness function selects the at least one optimal path between the first node and the second node by comparing the current passed along the plurality of paths in the electrical graph model.

14. The system of claim 12, wherein the electrical graph model is formed from a plurality of data stored in a data repository.

15. The system of claim 12, wherein at least some of the plurality of edges of the edge-weighted graph are equal.

16. The system of claim 12, further comprising a candidate generator that grows a first neighborhood of edges and nodes around the first node.

17. The system of claim 12, wherein the candidate generator further grows a second neighborhood of edges and nodes around the second node.

18. The system of claim 17, further comprising a pickHeuristic processor that identifies nodes in the second neighborhood that connect with the nodes in the first neighborhood.

19. The system of claim 18, wherein the pickHeuristic processor further identifies nodes in the first neighborhood that connect with the nodes in the second neighborhood.

20. The system of claim of claim 9, further comprising a stoppingCondition processor that determines a point at which paths formed between the first node and the second node from the first neighborhood to the second neighborhood are sufficient for selecting the at least one optimal path.

21. A method of a subgraph that contains at least a plurality of paths between a first node and a second node, comprising:
selecting the subgraph according to a goodness function from a plurality of subgraphs that satisfy a limitation on a number of nodes and edges that are allowable in the subgraph.

22. The method of claim 21, wherein selecting the subgraph according to the goodness function comprises generating a candidate graph that is smaller than a entire network.

23. The method of claim 22, wherein selecting the subgraph according to the goodness function further comprises computing a flow in the candidate graph.

24. The method of claim 23, wherein selecting the subgraph according to the goodness function comprises selecting a plurality of paths in the candidate graph according to a predetermined goodness measure.
